(19) United States
(12) Patent Application Publication
(10) Pub. No.: US 2026/0291403 A1
(43) Pub. Date: Sep. 24, 2026

(54) STARTUP PROCEDURE FOR FLYING CAPACITOR MULTI-LEVEL (FCML) CONVERTER

(71) Applicant: Murata Manufacturing Co., Ltd., Nagaokakyo-shi (JP)

(72) Inventors: Pingho YEE, Hong Kong (CN); Chuipong LIU, Hong Kong (CN)

(21) Appl. No.: 19/558,730

(22) Filed: Mar. 6, 2026

(30) Foreign Application Priority Data
Mar. 18, 2025 (CN) 202510319418.7

(51) Int. Cl. H02M 7/483; H02M 1/08

(52) U.S. Cl. CPC H02M 7/4837; H02M 1/08

(57) ABSTRACT

An FCML converter circuit includes an output capacitor; a first switching device, a fifth switching device, a current limiter, and a second switching device connected in series and connected in parallel with the output capacitor; a third switching device and a fourth switching device connected in series and connected in parallel with the current limiter and the fifth switching device; sixth switching devices connected in series, where a flying capacitor is connected across the sixth switching devices, and the sixth switching devices connected in series are connected in parallel with the output capacitor; a power input terminal and an inductor connected in series between a node between the third switching device and the fourth switching device and a node between two central sixth switching devices; and a controller, under the control of which, the electrical power received pre-charges the flying capacitor and the output capacitor.

### CROSS REFERENCE TO RELATED APPLICATIONS

This application claims the benefit of priority to Chinese Patent Application No. 202510319418.7 filed on Mar. 18, 2025. The entire contents of this application are hereby incorporated herein by reference.

### BACKGROUND OF THE INVENTION

### 1. Field of the Invention

The present disclosure relates to flying capacitor multi-level (FCML) converter circuits.

### 2. Description of the Related Art

Compared with traditional converters, a flying capacitor multi-level (FCML) converter divides voltage conversion into multiple stages (e.g., (N−1) stages in the case of an N-level FCML converter). This ensures a voltage across an inductor remains less than or equal to 1/(N−1) times an output voltage Vout and offers the following advantages:
1) A switching frequency of the inductor is (N−1) times a high-frequency (HF) switching frequency, allowing for a reduction in the inductor size.
2) A voltage across a high-frequency switching device in a steady state (where a voltage across a flying capacitor is well regulated to a designed level) is only 1/(N−1) times the output voltage Vout, allowing the use of low-voltage devices with lower on-resistance (Rdson) and better switching performance.

Accordingly, FCML converters may achieve higher efficiency and greater power density.

However, FCML converters encounter the following issues.

In a case where the input power source is an alternating current (AC) power source, when AC is turned on, voltage V_{FC} of flying capacitor (e.g., capacitors C₁ and C₂ in FIG. 1) may be equal to zero (if not pre-charged), and the voltage across top or bottom HF FET (field-effect transistor) (depending on an AC phase angle) is equal to Vbulk, which exceeds the voltage rating of the device.

For example, as shown in FIG. 1, a 4-level FCML PFC (power factor correction) converter is used as an example. When 305 Vac at 90 degrees is applied, body diodes of switching devices Q₁, Q₂, and Q₃ are forward biased to charge the bulk capacitor (capacitor C₃ in FIG. 1). Since the voltage across flying capacitors C₁ and C₂ is zero (without pre-charging), the voltage across the bottom switching device Q₆ is equal to Vbulk, i.e., 431 Vdc, which is far greater than the voltage during steady-state operation (Vbulk/3), resulting in the use of low-voltage devices impossible. The same situation occurs when AC at 270 degrees is applied, where the voltage across the top switching device Q₁ is equal to Vbulk.

Therefore, to ensure reliability, pre-charging and regulation of flying capacitors are critical.

Currently, the following methods are employed to address these issues: passive methods may be used to generate reference voltages for charging of the flying capacitors. An N-level FCML converter requires (N−2) different reference voltage divider networks. For example, as shown in FIG. 2, in a case of a 3-level FCML converter, one reference voltage divider network is required for charging the flying capacitors. The number of divider networks is proportional to the number of levels N, and a higher value of N results in more divider networks. Although the number of divider networks may be reduced using HF FETs with higher voltage rating, this would compromise efficiency and is therefore unsuitable for N-level designs.

Furthermore, in a case where the input power source is a direct current (DC) power source, when a high DC voltage is applied to the converter, the voltage V_{FC} of the flying capacitor is equal to zero (without pre-charging), and the voltage across the HF FET connected to the flying capacitor and the output capacitor Cₒᵤₜ (capacitor C₃ in FIG. 3) instantly become equal to Vout (e.g., switching device Q₁ or Q₆ in a 4-level FCML converter in FIG. 3, depending on the DC polarity), which exceeds the voltage rating of the device.

As shown in FIG. 3, a 4-level FCML converter is used as an example. When 300 Vdc is applied, the body diodes of the switching devices Q₁, Q₂, and Q₃ are forward biased to charge capacitor C₃. As the voltage across capacitors C₁ and C₂ is zero (without pre-charging), the voltage across switching device Q₆ at 300 Vdc is equal to Vout, which is far greater than the voltage at steady-state operation (Vout/3), making the use of low-voltage devices impossible (assuming target Vout=450 Vdc). When −300 Vdc is applied, the voltage across switching device Q₁ is equal to Vout.

Therefore, as described above, pre-charging and regulation of the flying capacitors are critical to ensure reliability. Moreover, switching devices Q₇ and Q₈ are used to accommodate non-fixed DC polarity in applications.

The aforementioned passive methods may also be used to generate reference voltages for charging of the flying capacitors. An N-level FCML converter requires (N−2) different reference voltage divider networks. For example, as shown in FIG. 4, in a case of a 3-level FCML converter, one reference voltage divider network is required for charging the flying capacitors. The number of divider networks is proportional to the number of levels N, and a higher value of N results in more divider networks. Although the number of divider networks may be reduced using HF FETs with higher voltage rating, this would compromise efficiency and is therefore unsuitable for N-level designs.

### SUMMARY OF THE INVENTION

Example embodiments of the present disclosure provide flying capacitor multi-level (FCML) converter circuits capable of addressing one or more shortcomings of the related art.

According to an example embodiment of the present disclosure, a flying capacitor multi-level (FCML) converter circuit includes an output capacitor connected in parallel across output terminals; a first switching device, a fifth switching device, a current limiter, and a second switching device connected in series with each other and are connected in parallel with the output capacitor, where the fifth switching device is integrated with the first switching device and the second switching device to function as a bidirectional switch (BDS); a third switching device and a fourth switching device connected in series with each other and are connected in parallel with the current limiter and the fifth switching device, where the third switching device and the fourth switching device function as bypass switches; a plurality of sixth switching devices connected in series, where a flying capacitor is connected across the plurality of sixth switching devices, and the plurality of sixth switching devices connected in series are connected in parallel with the output capacitor; a power input terminal and an inductor connected in series between a node between the third switching device and the fourth switching device and a node between two central sixth switching devices among the plurality of sixth switching devices, where the power input terminal is configured to receive electrical power; and a controller coupled to the power input terminal; where, under the control of the controller, the electrical power received by the power input terminal pre-charges the flying capacitor and the output capacitor through a corresponding sixth switching device among the plurality of sixth switching devices, the first switching device, the second switching device, the third switching device, the fourth switching device, the fifth switching device, and the current limiter.

According to an example embodiment of the present disclosure, the FCML converter circuit further includes: a driving circuit coupled to the controller, where the controller is configured to control turn-on and turn-off of the first switching device, the second switching device, the third switching device, the fourth switching device, the fifth switching device, and the plurality of sixth switching devices through the driving circuit.

According to an example embodiment of the present disclosure, the FCML converter circuit further includes an auxiliary converter coupled to the power input terminal and to the controller, where the power input terminal is configured to receive electrical power from an external power source, and where prior to the pre-charging with the electrical power received by the power input terminal, the auxiliary converter is powered up first by receiving electrical power from the power input terminal to provide an internal voltage.

According to an example embodiment of the present disclosure, the FCML converter circuit is an N-level FCML converter, and N is a positive integer greater than or equal to 3; the plurality of sixth switching devices include 2×(N−1) sixth switching devices, the flying capacitors include (N−2) flying capacitors, an i-th flying capacitor is connected across an (N−1−i)-th sixth switching device and an (N+i)-th sixth switching device among the 2×(N−1) sixth switching devices, where i=1, 2, . . . , N−2; and the (N−2) flying capacitors have (N−2) different target flying capacitor voltage levels.

According to an example embodiment of the present disclosure, the plurality of sixth switching devices include high-frequency (HF) field-effect transistors (FETs), the inductor is connected to a source of an (N−1)-th sixth switching device and a drain of an N-th sixth switching device, and the i-th flying capacitor among the (N−2) flying capacitors is connected across a source of the (N−1−i)-th sixth switching device and a drain of the (N+i)-th sixth switching device among the 2×(N−1) sixth switching devices.

According to an example embodiment of the present disclosure, the external power source is an alternating current (AC) power source, and prior to the pre-charging with the electrical power received by the power input terminal, the auxiliary converter is powered up first to provide an internal voltage, such that the controller monitors the AC power source to control a BDS turn-on phase angle and initiate the pre-charging; and where the controller is further configured to acquire a peak voltage V_{acpeak} of the AC power source and to continuously monitor an input voltage Vᵢₙ of the AC power source and a voltage V_{c} of the output capacitor.

According to an example embodiment of the present disclosure, when a live line is positive, current flows through the second switching device, the current limiter, the fifth switching device, and the third switching device, where: when the input voltage Vᵢₙ is greater than (i−1)×V_{acpeak}/(N−1) and less than or equal to i×V_{acpeak}/(N−1), a 1^{st} sixth switching device to an (N+i−1)-th sixth switching device are turned off, an (N+i)-th sixth switching device to a (2N−2)-th sixth switching device are turned on, and the AC power source charges an i-th flying capacitor to an (N−2)-th flying capacitor and the output capacitor through conduction of body diodes of the 1^{st} sixth switching device to the (N−1)-th sixth switching device, and when the input voltage Vᵢₙ is greater than (N−2)×V_{acpeak}/(N−1) and less than or equal to the peak voltage V_{acpeak}, the 1^{st} sixth switching device to the (2N−2)-th sixth switching device are turned off, and the AC power source charges the output capacitor through conduction of body diodes of the 1^{st} sixth switching device to the (N−1)-th sixth switching device.

According to an example embodiment of the present disclosure, when a neutral line is positive, current flows through the fourth switching device, the current limiter, the fifth switching device, and the first switching device, where: when the input voltage Vᵢₙ is greater than (i−1)×V_{acpeak}/(N−1) and less than or equal to i×V_{acpeak}/(N−1), the (N−i)-th sixth switching device to the (2N−2)-th sixth switching device are turned off, the 1^{st} sixth switching device to the (N−1−i)-th sixth switching device are turned on, and the AC power source charges the i-th flying capacitor to the (N−2)-th flying capacitor and the output capacitor through conduction of body diodes of the N-th sixth switching device to the (2N−2)-th sixth switching device, and when the input voltage Vᵢₙ is greater than (N−2)×V_{acpeak}/(N−1) and less than or equal to the peak voltage V_{acpeak}, the 1^{st} sixth switching device to the (2N−2)-th sixth switching device are turned off, and the AC power source charges the output capacitor through conduction of body diodes of the N-th sixth switching device to the (2N−2)-th sixth switching device.

According to an example embodiment of the present disclosure, when the voltage V_{c} reaches the peak voltage V_{acpeak}, the (N−2) flying capacitors and the output capacitor are charged to target levels, and the third switching device and the fourth switching device are turned on.

According to an example embodiment of the present disclosure, through turn-on and turn-off of the plurality of sixth switching devices, the AC power source charges all the (N−2) flying capacitors and the output capacitor within one AC cycle.

According to an example embodiment of the present disclosure, the external power source is a direct current (DC) power source, and prior to the pre-charging with the electrical power received by the power input terminal, the auxiliary converter is powered up first to provide an internal voltage, such that the controller is configured to measure an input voltage Vᵢₙ and polarity of the DC power source to initiate the pre-charging; and where the controller is further configured to continuously monitor the voltage V_{c} of the output capacitor.

According to an example embodiment of the present disclosure, when the polarity is positive, current flows through the second switching device, the current limiter, the fifth switching device, and the third switching device, where: when the voltage V_{c} is greater than (i−1)×Vᵢₙ/(N−1) and less than or equal to i×Vᵢₙ/(N−1), the 1^{st} sixth switching device to the (N+i−1)-th sixth switching device are turned off, the (N+i)-th sixth switching device to the (2N−2)-th sixth switching device are turned on, and the DC power source charges the i-th flying capacitor to the (N−2)-th flying capacitor and the output capacitor through conduction of body diodes of the 1^{st} sixth switching device to the (N−1)-th sixth switching device, and when the voltage V_{c} is greater than (N−2)×Vᵢₙ/(N−1) and less than or equal to Vᵢₙ, the 1^{st} sixth switching device to the (2N−2)-th sixth switching device are turned off, and the DC power source charges the output capacitor through conduction of body diodes of the 1^{st} sixth switching device to the (N−1)-th sixth switching device.

According to an example embodiment of the present disclosure, when the polarity is negative, current flows through the fourth switching device, the current limiter, the fifth switching device, and the first switching device, where: when the voltage V_{c} is greater than (i−1)×Vᵢₙ/(N−1) and less than or equal to i×Vᵢₙ/(N−1), the (N−i)-th sixth switching device to the (2N−2)-th sixth switching device are turned off, the 1^{st} sixth switching device to the (N−1−i)-th sixth switching device are turned on, and the DC power source charges the i-th flying capacitor to the (N−2)-th flying capacitor and the output capacitor through conduction of body diodes of the N-th sixth switching device to the (2N−2)-th sixth switching device, and when the voltage V_{c} is greater than (N−2)×Vᵢₙ/(N−1) and less than or equal to Vᵢₙ, the 1^{st} sixth switching device to the (2N−2)-th sixth switching device are turned off, and the DC power source charges the output capacitor through conduction of body diodes of the N-th sixth switching device to the (2N−2)-th sixth switching device.

According to an example embodiment of the present disclosure, when the voltage V_{c} approaches the input voltage Vᵢₙ, the (N−2) flying capacitors and the output capacitor are charged to target levels, and the third switching device and the fourth switching device are turned on.

According to example embodiments of the present disclosure, all the flying capacitors may be gradually charged to ensure that the HF FETs are not overloaded, thereby ensuring reliability.

The above and other elements, features, steps, characteristics and advantages of the present invention will become more apparent from the following detailed description of the example embodiments with reference to the attached drawings.

### BRIEF DESCRIPTION OF THE DRAWINGS

Other objectives, features, and advantages will become apparent from the detailed description of the example embodiments made with reference to the following accompanying drawings.

FIG. 1 shows a circuit diagram of a 4-level FCML converter for an AC power source according to the related art.

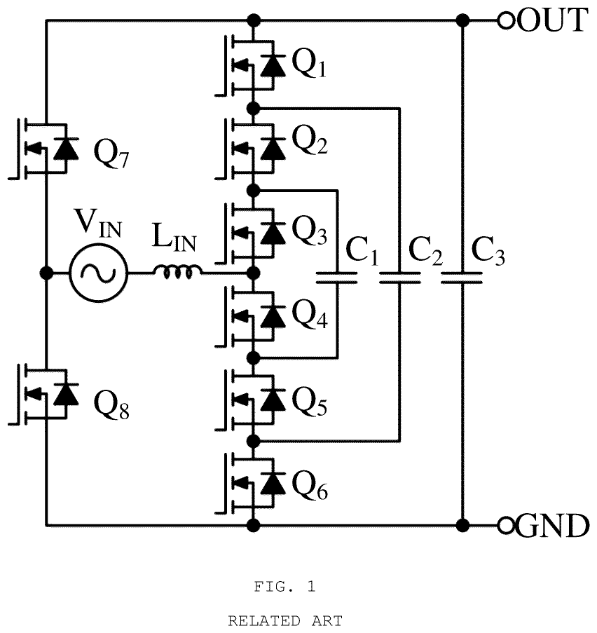

FIG. 2 shows a schematic diagram of a divider network of an FCML converter for an AC power source according to the related art.

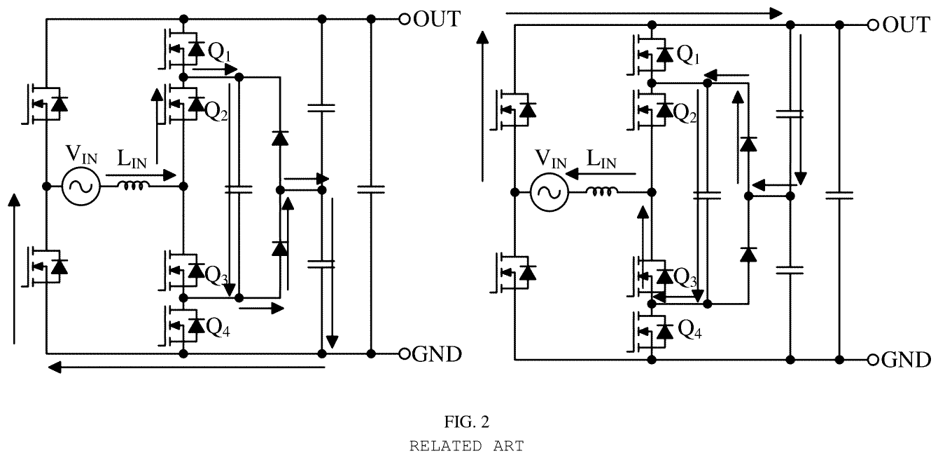

FIG. 3 shows a circuit diagram of a 4-level FCML converter for a DC power source according to the related art.

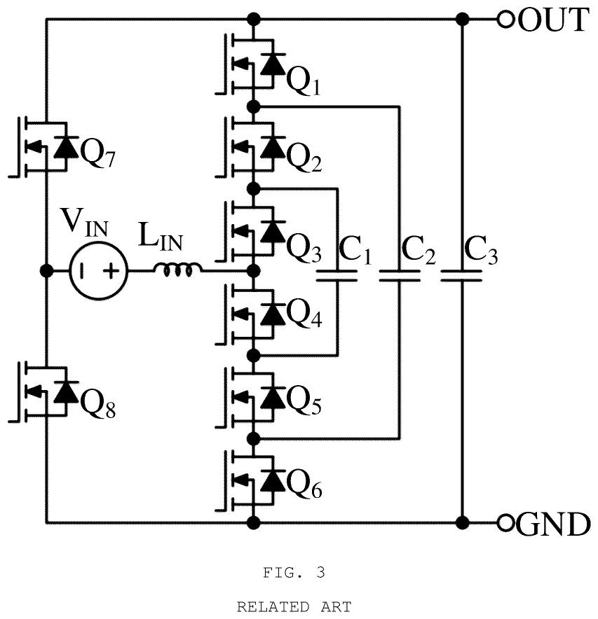

FIG. 4 shows a schematic diagram of a divider network of an FCML converter for a DC power source according to the related art.

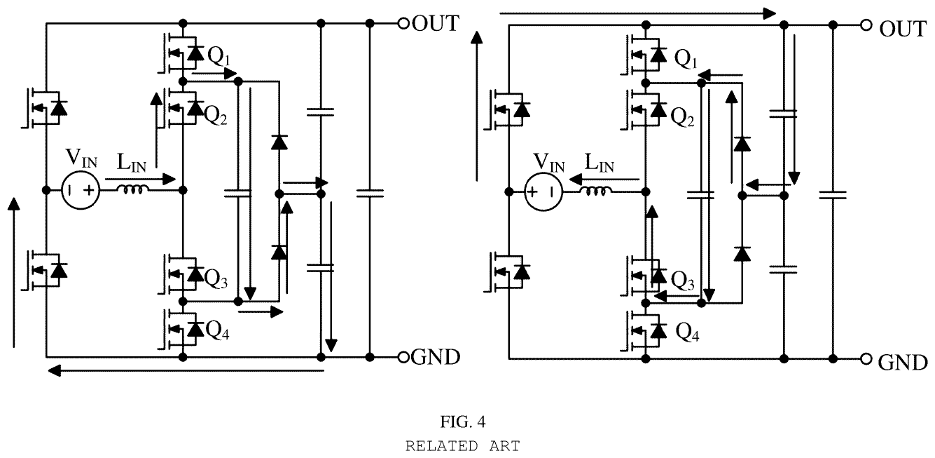

FIG. 5 shows a circuit diagram of an FCML converter circuit according to an example embodiment of the present disclosure.

FIG. 6 shows a circuit diagram of a 4-level FCML converter circuit for an AC power source according to an example embodiment of the present disclosure.

FIGS. 7A to 7C show schematic diagrams of a flying capacitor pre-charging process when the live line L is positive, according to an example embodiment of the present disclosure.

FIGS. 8A to 8C show schematic diagrams of a flying capacitor charging process when the neutral line N is positive, according to an example embodiment of the present disclosure.

FIG. 9 shows a waveform diagram of voltage levels of the flying capacitors and the output capacitor during pre-charging based on a target output voltage in a case of an AC power source according to an example embodiment of the present disclosure.

FIG. 10 shows a waveform diagram of voltage levels of the flying capacitors and the output capacitor during pre-charging based on an AC peak voltage in a case of an AC power source according to an example embodiment of the present disclosure.

FIG. 11 shows a circuit diagram of a 4-level FCML converter circuit for a DC power source according to an example embodiment of the present disclosure.

FIGS. 12A to 12C show schematic diagrams of a flying capacitor pre-charging process when the polarity is positive according to an example embodiment of the present disclosure.

FIGS. 13A to 13C show schematic diagrams of a flying capacitor charging process when the polarity is negative according to an example embodiment of the present disclosure.

FIG. 14 shows a waveform diagram of voltage levels of the flying capacitors and the output capacitor during pre-charging in a case of a DC power source according to an example embodiment of the present disclosure.

### DETAILED DESCRIPTION OF THE EXAMPLE EMBODIMENTS

The example embodiments of the present disclosure will be described below with reference to the accompanying drawings. In the accompanying drawings, identical components are denoted by identical reference numerals, and repetitive descriptions thereof are omitted. However, it should be understood that these descriptions are merely exemplary and are not intended to limit the scope of the present disclosure. Additionally, in the following description, well-known structures and techniques are omitted to avoid unnecessarily obscuring the concepts of the present disclosure.

The terms used herein are intended only to describe specific example embodiments and are not intended to limit the present disclosure. As used herein, the expressions “a”, “an”, and “the” are intended to include “plurality of” and “various” unless the context explicitly indicates otherwise. Furthermore, the terms “comprising”, “including”, etc. used herein indicate the presence of stated features, steps, operations, and/or components, but do not preclude the presence or addition of one or more other features, steps, operations, or components.

All terms (including technical and scientific terms) used herein have meanings commonly understood by those skilled in the art unless otherwise defined. It should be noted that the terms used herein should be interpreted in a manner consistent with their usage in the context of this specification and should not be interpreted in an idealized or overly rigid manner.

The following describes a power startup procedure and a flying capacitor pre-charging mechanism.

First, the following design considerations are considered.

In a case where the external power source is an alternating current (AC) power source: 1) a mechanical relay or solid-state relay is not connected in series with the bulk capacitor, because according to KVL (Kirchhoff's Voltage Law), the voltage across the FET will follow the AC; 2) if pre-charging is performed through HF FET switching, the auxiliary converter is powered up before the AC voltage is applied to the FCML converter; and 3) since AC may be applied at any phase angle, the pre-charging circuit or process accommodates both cases where L (live line) or N (neutral line) is positive in polarity.

In a case where the external power source is a direct current (DC) power source: 1) a mechanical relay or solid-state relay with a current limiter is used to slow down the charging of output capacitor Cₒᵤₜ and to reduce a rate of voltage rise across the HF FET; 2) if pre-charging is performed through HF FET switching, the auxiliary converter is powered up before DC is applied to the FCML converter; and 3) since the polarity of the DC applied to the FCML converter is not fixed, the pre-charging circuit or process accommodates both polarities.

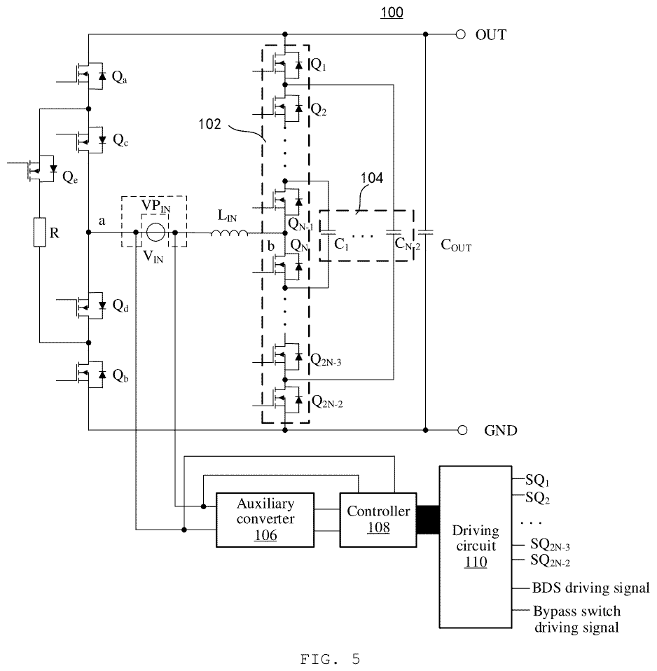

Based on the design considerations for the two power source scenarios described above, an FCML converter circuit is proposed, as shown in FIG. 5. FIG. 5 shows a circuit diagram of an FCML converter circuit 100 according to an example embodiment of the present disclosure. In an example embodiment of the present disclosure, the FCML converter circuit 100 may include an output capacitor C_{OUT}, a first switching device Qₐ, a second switching device Q_{b}, a third switching device Q_{c}, a fourth switching device Q_{d}, a fifth switching device Qₑ, a plurality of sixth switching devices 102 connected in series, a current limiter R, a power input terminal VP_{IN}, an inductor L_{IN}, an auxiliary converter 106, and a controller 108.

In an example embodiment, the output capacitor C_{OUT} may be connected in parallel across output terminals. For example, the output capacitor C_{OUT} may be connected between an output terminal OUT and a ground terminal GND. The first switching device Qₐ, the fifth switching device Qₑ, the current limiter R, and the second switching device Q_{b} may be connected in series with each other and may be connected in parallel with the output capacitor C_{OUT}.

In example embodiments of the present disclosure, it is proposed to add a solid-state switch (e.g., the fifth switching device Qₑ) connected in series with the current limiter R. The solid-state switch is integrated with the first switching device Qₐ and the second switching device Q_{b} to function as a bidirectional switch (BDS). When the BDS is turned off, the input is completely disconnected from the converter. Furthermore, the BDS may be driven faster, allowing control of an AC power-up phase angle. In an example embodiment, the fifth switching device Qₑ may be integrated with the first switching device Qₐ and the second switching device Q_{b} to function as a bidirectional switch (BDS).

Furthermore, to compensate for conduction loss, an additional switch is used in parallel with the solid-state switch and the current limiter. That is, in an example embodiment, the third switching device Q_{c} and the fourth switching device Q_{d} may be connected in series with each other and may be connected in parallel with the current limiter R and the fifth switching device Qₑ. Here, the third switching device Q_{c} and the fourth switching device Q_{d} may function as bypass switches.

In an example embodiment, a flying capacitor 104 may be connected across the plurality of sixth switching devices 102 connected in series, and the plurality of sixth switching devices 102 connected in series may be connected in parallel with the output capacitor C_{OUT}. In an example embodiment, the plurality of sixth switching devices 102 may be FETs, but the present disclosure is not limited thereto.

In an example embodiment, the power input terminal VP_{IN} and the inductor L_{IN} may be connected in series between a node a and a node b as shown in FIG. 5. Here, the node a may be a node between the third switching device Q_{c} and the fourth switching device Q_{d}, and the node b may be a node between two central switching devices among the plurality of switching devices 102. In an example embodiment, the power input terminal VP_{IN} may be configured to receive electrical power. Here, the power input terminal VP_{IN} may receive electrical power from an external power source V_{IN}, where the external power source V_{IN} may be an AC power source or a DC power source. The flying capacitor pre-charging process will be described separately for the cases where the external power source V_{IN} is an AC power source and the external power source V_{IN} is a DC power source. In an example embodiment, before the FCML converter is powered up, initial voltages of the flying capacitor 104 and the output capacitor C_{OUT} may be zero.

Based on the above design considerations, before the FCML converter is powered up (i.e., before pre-charging is performed with the electrical power received by the power input terminal VP_{IN}), the auxiliary converter 106 is powered up first to provide an internal voltage Vcc. When AC is applied, because the fifth switching device Qₑ is turned off, the external power source V_{IN} is not allowed to charge the output capacitor C_{OUT}, and only the auxiliary converter 106 may be powered up to provide the internal voltage Vcc. In an example embodiment, the auxiliary converter 106 may be coupled to the power input terminal VP_{IN} and may be powered up first to provide the internal voltage Vcc by receiving electrical power from the power input terminal VP_{IN} before the FCML converter is powered up. Here, the auxiliary converter 106 may convert a high voltage to a low voltage, but example embodiments of the present disclosure are not limited thereto. Moreover, the auxiliary converter 106 may include an additional bridge rectifier (not shown).

In an example embodiment, the controller 108 may be coupled to the power input terminal VP_{IN} and the auxiliary converter 106. Under the control of the controller 108, the electrical power received by the power input terminal VP_{IN} may pre-charge the plurality of flying capacitors 104 and the output capacitor C_{OUT} through the corresponding sixth switching device among the plurality of sixth switching devices 102, the first switching device Qₐ, the second switching device Q_{b}, the third switching device Q_{c}, the fourth switching device Q_{d}, the fifth switching device Qₑ, and the current limiter R. Here, the controller 108 may be a microcontroller unit (MCU), but example embodiments of the present disclosure are not limited thereto.

Moreover, the FCML converter circuit 100 may further include a driving circuit 110 attached to the controller 108. In an example embodiment, the controller 108 may control turn-on (ON) and turn-off (OFF) of the plurality of sixth switching devices 102, the first switching device Qₐ, the second switching device Q_{b}, the third switching device Q_{c}, the fourth switching device Q_{d}, and the fifth switching device Qₑ through the driving circuit 110. For example, the controller 108 may control turn-on and turn-off of the first switching device Qₐ, the second switching device Q_{b}, the third switching device Q_{c}, the fourth switching device Q_{d}, the fifth switching device Qₑ, and the plurality of sixth switching devices 102 using respective driving signals (for example, driving signal SQ, BDS driving signal, bypass switch driving signal, etc.). The driving signal SQ may be used to control the plurality of sixth switching devices 102, the BDS driving signal may be used to control the BDS, and the bypass switch driving signal may be used to control the bypass switches. Here, the fifth switching device Qₑ may function as a BDS by being integrated with the first switching device Qₐ and the second switching device Q_{b}, and the third switching device Q_{c} and the fourth switching device Q_{d} serve as bypass switches.

In an example embodiment, the FCML converter circuit 100 is an N-level FCML converter, where N is a positive integer greater than or equal to 3. Accordingly, the plurality of sixth switching devices 102 may include 2×(N−1) sixth switching devices, namely a 1^{st} sixth switching device Q₁ to a (2N−2)-th sixth switching device Q_{2N-2}. The flying capacitors 104 may include (N−2) flying capacitors, namely a first flying capacitor C₁ to an (N−2)-th flying capacitor C_{N-2}. Here, an i-th flying capacitor Cᵢ may be connected across the (N−1−i)-th sixth switching device Q_{N-1-i} and the (N+i)-th sixth switching device Q_{N+i} among the 2×(N−1) sixth switching devices, where i=1, 2, . . . , N−2. As described above, the sixth switching devices may be FETs. Therefore, the i-th flying capacitor among the (N−2) flying capacitors may be connected across a source of the (N−1−i)-th sixth switching device and a drain of the (N+i)-th sixth switching device among the 2×(N−1) sixth switching devices. In an example embodiment, the flying capacitors 104 may have (N−2) different target flying capacitor voltage levels.

Next, the pre-charging process will be described separately for two cases where the external power source V_{IN} is an AC power source and the external power source V_{IN} is a DC power source. In the following description, the controller 108 may refer to an MCU, and the sixth switching devices 102 may refer to high-frequency (HF) FETs.

In Case 1, the external power source V_{IN} is an AC power source.

As described above, prior to the pre-charging with the electrical power received by the power input terminal VP_{IN}, the auxiliary converter 106 is powered up first to provide the internal voltage Vcc. Once all internal voltages Vcc are ready, the main MCU monitors the AC to control a BDS turn-on phase angle and initiate the pre-charging process. In an example embodiment, prior to the pre-charging with the electrical power received by the power input terminal VP_{IN}, the auxiliary converter 106 may be powered up first to provide the internal voltage Vcc, enabling the controller to monitor the AC power source to control the BDS turn-on phase angle and initiate the pre-charging. In an example embodiment, the controller 108 may monitor the phase angle of the AC power source and control the BDS to turn on when the phase angle is 0 degrees. However, example embodiments of the present disclosure are not limited thereto. The BDS turn-on phase angle may include an offset or may be an arbitrary angle, depending on the power source and circuit configuration. Moreover, the controller 108 may acquire a peak voltage V_{acpeak} of the AC power source and may continuously monitor the input voltage Vᵢₙ of the AC power source and the voltage V_{c} of the output capacitor C_{OUT}.

Here, the FCML converter circuit 100 may be an FCML PFC converter.

Under the control of the controller, once the BDS is turned on, the voltage across the HF FET may increase following the voltage V_{C}. By appropriately controlling ON/OFF of the HF FET, all of the flying capacitors 104 may be charged within one AC cycle. In an example embodiment, through ON/OFF of the plurality of sixth switching devices 102, the AC power source may charge all the flying capacitors 104 and the output capacitor C_{OUT} within one AC cycle.

When the live line L is positive, all bottom HF FETs except Q_{N} are turned on (for an N-level FCML converter, it may include 2×(N−1) HF FETs in series, and the PFC inductor may be connected to the source of Q_{N-1} and the drain of Q_{N}) to charge all the flying capacitors (e.g., C₁ to C_{N-2}) and the bulk capacitor (i.e., the output capacitor, such as C_{OUT}) because they are now connected in parallel.

That is, the N-th sixth switching device Q_{N} may be turned off, the (N+1)-th sixth switching device Q_{N+1} to the (2N−2)-th sixth switching device Q_{2N-2} may be turned on, and the body diodes of the 1^{st} sixth switching device Q₁ to the (N−1)-th sixth switching device Q_{N-1} are forward biased. Accordingly, current may flow through the second switching device Q_{b}, the current limiter R, the fifth switching device Qₑ, the third switching device Q_{c}, and all the sixth switching devices except Q_{N} among the plurality of sixth switching devices 102, to charge all the flying capacitors and the output capacitor C_{OUT}. At this time, the AC power source may charge all the flying capacitors (e.g., C₁ to C_{N-2}) and the output capacitor (e.g., C_{OUT}). (N−2) different target flying capacitor voltage levels may be used.

When the AC voltage (i.e., the input voltage Vᵢₙ) approaches a first target flying capacitor voltage level (i.e., (1/(N−1))×V_{acpeak}), the switching device Q_{N+1} is turned off, causing C₁ to be disconnected from the AC and stop being charged. All remaining flying capacitors and the bulk capacitor continue being charged to a next voltage level. For an N-level, FCML PFC converter, the charging process of the flying capacitors 104 and the bulk capacitor (e.g., the output capacitor C_{OUT}) is divided into (N−1) states, where switching devices Q_{N+i}, . . . , Q_{2×(N-1)} are turned on to charge flying capacitors Cᵢ, . . . , C_{N-2}, while the output capacitor C_{OUT} may be charged regardless of whether the HF FETs are turned on or turned off.

In an example embodiment, when the input voltage Vᵢₙ is greater than (i−1)×V_{acpeak}/(N−1) and less than or equal to i×V_{acpeak}/(N−1), the 1^{st} sixth switching device Q₁ to the (N+i−1)-th sixth switching device Q_{N+i-1} are turned off, the (N+i)-th sixth switching device Q_{N+i} to the (2N−2)-th sixth switching device Q_{2N-2} are turned on, and the AC power source may charge the i-th flying capacitor Cᵢ to the (N−2)-th flying capacitor C_{N-2} and the output capacitor C_{OUT} through conduction of the body diodes of the 1^{st} sixth switching device Q₁ to the (N−1)-th sixth switching device Q_{N-1}. When the input voltage Vᵢₙ is greater than (N−2)×V_{acpeak}/(N−1) and less than or equal to the peak voltage V_{acpeak}, the 1^{st} sixth switching device Q₁ to the (2N−2)-th sixth switching device Q_{2N-2} are turned off, and the AC power source may charge the output capacitor C_{OUT} through conduction of the body diodes of the 1^{st} sixth switching device Q₁ to the (N−1)-th sixth switching device Q_{N-1}.

When the neutral line N is positive, the situation is similar. The only difference is that all turn-on and turn-off operations occur on the top FETs (Q₁, . . . , Q_{N-1}).

That is, the (N−1)-th sixth switching device Q_{N-1} may be turned off, the 1^{st} sixth switching device Q₁ to the (N−2)-th sixth switching device Q_{N-2} may be turned on, and the body diodes of the N-th sixth switching device Q_{N} to the (2N−2)-th sixth switching device Q_{2N-2} are forward biased. Accordingly, current may flow through the fourth switching device Q_{d}, the current limiter R, the fifth switching device Qₑ, the first switching device Qₐ, and all the sixth switching devices except Q_{N-1} among the plurality of sixth switching devices 102, to charge all the flying capacitors 104 and the output capacitor C_{OUT}. At this time, the AC power source may charge all the flying capacitors (e.g., C₁ to C_{N-2}) and the output capacitor (e.g., C_{OUT}).

When the AC voltage (i.e., the input voltage Vᵢₙ) approaches the first target flying capacitor voltage level (i.e., (1/(N−1))×V_{acpeak}), the switching device Q_{N-2} is turned off, causing flying capacitor C₁ to be disconnected from the AC power source and stop being charged. All remaining flying capacitors and the bulk capacitor (e.g., the output capacitor C_{OUT}) continue being charged to the next voltage level. Switching devices Q₁, . . . , Q_{N-1-i} are turned on to charge flying capacitors Cᵢ, . . . , C_{N-2}, while the output capacitor C_{OUT} may be charged regardless of whether the HF FETs are turned on or turned off.

In an example embodiment, when the input voltage Vin is greater than (i−1)×V_{acpeak}/(N−1) and less than or equal to i×V_{acpeak}/(N−1), the (N−i)-th sixth switching device Q_{N-i} to the (2N−2)-th sixth switching device Q_{2N-2} are turned off, the 1^{st} sixth switching device Q₁ to the (N−1−i)-th sixth switching device Q_{N-1-i} are turned on, and the AC power source may charge the i-th flying capacitor Cᵢ to the (N−2)-th flying capacitor C_{N-2} and the output capacitor C_{OUT} through conduction of the body diodes of the N-th sixth switching device Q_{N} to the (2N−2)-th sixth switching device Q_{2N-2}. When the input voltage Vᵢₙ is greater than (N−2)×V_{acpeak}/(N−1) and less than or equal to the peak voltage V_{acpeak}, the 1^{st} sixth switching device Q₁ to the (2N−2)-th sixth switching device Q_{2N-2} are turned off, and the AC power source may charge the output capacitor C_{OUT} through conduction of the body diodes of the N-th sixth switching device Q_{N} to the (2N−2)-th sixth switching device Q_{2N-2}.

After the n-th AC cycle, all the flying capacitors 104 and the output capacitor C_{OUT} may be charged to their target voltage levels. Here, the phase angle is used to control the charging of the flying capacitors 104, and the voltage of the output capacitor C_{OUT} is continuously monitored. When the voltage of the output capacitor C_{OUT} reaches the AC peak voltage V_{acpeak}, the flying capacitors 104 are also charged to their target voltages. After the pre-charging is complete, that is, when the voltage V_{c} of the output capacitor C_{OUT} approaches the peak voltage V_{acpeak}, the flying capacitors 104 and the output capacitor C_{OUT} are charged to their target levels, and the bypass switches (i.e., the third switching device Q_{c} and the fourth switching device Q_{d}) may be turned on to initiate operation as a normal N-level FCML converter in a soft-start manner.

It should be noted that the number of flying capacitor voltage levels (i.e., the number of charging states) may be reduced depending on the voltage rating of the HF FETs. That is, higher voltage rating of HF FETs allows a reduction in the number of levels.

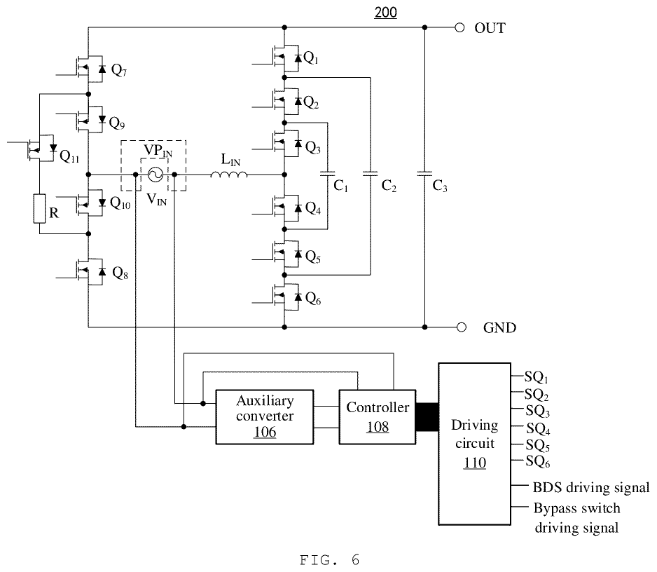

To further illustrate the above process in detail, reference is now made to FIG. 6 to FIGS. 8A to 8C, in which a 4-level FCML converter (i.e., N=4) is used as an example to illustrate the flying capacitor pre-charging process for an AC power source.

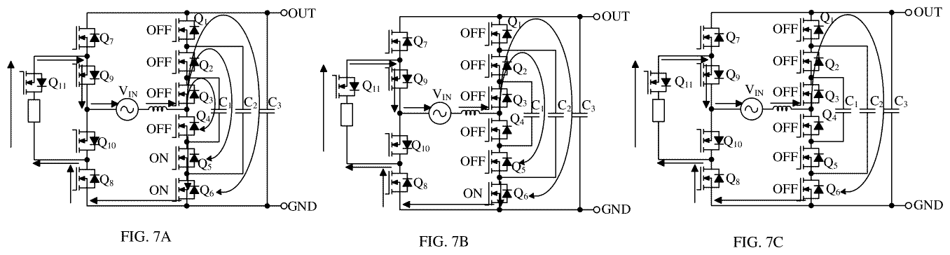

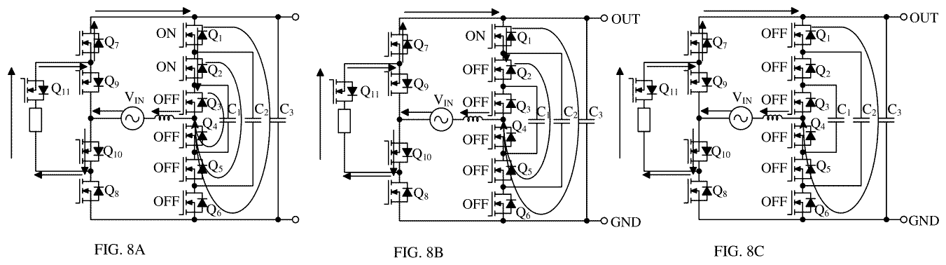

FIG. 6 shows a schematic diagram of a 4-level FCML converter circuit 200 for an AC power source according to an example embodiment of the present disclosure. FIGS. 7A to 7C show schematic diagrams of a flying capacitor pre-charging process when the live line L is positive according to an example embodiment of the present disclosure. FIGS. 8A to 8C show schematic diagrams of a flying capacitor pre-charging process when the neutral line N is positive according to an example embodiment of the present disclosure.

As shown in FIG. 6, the plurality of sixth switching devices (e.g., 102 in FIG. 5) may include six switching devices, namely Q₁ to Q₆. The plurality of flying capacitors (e.g., 104 in FIG. 5) may include two flying capacitors, namely C₁ and C₂. Here, the flying capacitor C₁ may be connected across the switching device Q₂ and the switching device Q₅, and the flying capacitor C₂ may be connected across the switching device Q₁ and the switching device Q₆. For a 4-level FCML PFC converter, the charging process of the flying capacitors and the bulk capacitor (i.e., capacitor C₃, which corresponds to C_{OUT} in FIG. 5) is divided into three states.

As shown in FIGS. 7A to 7C, when the live line L is positive, the body diodes of the switching devices Q₁, Q₂, and Q₃ are forward biased:
When the input voltage Vᵢₙ≤V_{acpeak}/(4−1), the switching device Q₄ is turned off (OFF), and the switching devices Q₅ and Q₆ are turned on (ON), so that the capacitors C₁, C₂, and C₃ may be charged as indicated by the arrow path shown in FIG. 7A. That is, the AC power source may charge the capacitors C₁, C₂, and C₃ through switching device Q₈ (e.g., the second switching device Q_{b} in FIG. 5), the current limiter R, switching device Q₁₁ (e.g., the fifth switching device Qₑ in FIG. 5), switching device Q₉ (e.g., the third switching device Q_{c} in FIG. 5), switching devices Q₃, Q₂, Q₁, Q₅, and Q₆. Here, Vᵢₙ may be the input voltage of the AC power source obtained by the controller 108, and the capacitors C₁, C₂, and C₃ are charged at different AC phase angles. The controller 108 may measure the level of the input voltage Vᵢₙ and control the sixth switching devices (i.e., Q₁ to Q₆) through the driving circuit 110. In addition, V_{acpeak} is the peak voltage of the AC power source.
When V_{acpeak}/(4−1)<Vᵢₙ≤2×V_{acpeak}/(4−1), the switching devices Q₄ and Q₅ are turned off, and the switching device Q₆ is turned on, so that the capacitors C₂ and C₃ may be as indicated by the arrow path shown in FIG. 7B. That is, the AC power source may charge the capacitors C₂ and C₃ through Q₈, the current limiter R, switching devices Q₁₁, Q₉, Q₃, Q₂, Q₁, and Q₆.
When 2×V_{acpeak}/(4−1)<Vᵢₙ≤V_{acpeak}, the switching devices Q₄, Q₅, and Q₆ are all turned off, so that only the capacitor C₃ is charged as indicated by the arrow path shown in FIG. 7C. That is, the AC power source may charge the capacitor C₃ through Q₈, the current limiter R, switching devices Q₁₁, Q₉, Q₃, Q₂, and Q₁.

As shown in FIGS. 8A to 8C, when the neutral line N is positive, the body diodes of the switching devices Q₄, Q₅, and Q₆ are forward biased:
When Vᵢₙ≤V_{acpeak}/(4−1), the switching device Q₃ is turned off, and the switching devices Q₁ and Q₂ are turned on, so that the capacitors C₁, C₂, and C₃ may be charged as indicated by the arrow path shown in FIG. 8A. That is, the AC power source may charge the capacitors C₁, C₂, and C₃ through Q₁₀, the current limiter R, switching devices Q₁₁, Q₇, Q₁, Q₂, Q₆, Q₅, and Q₄.
When V_{acpeak}/(4−1)<Vᵢₙ≤2×V_{acpeak}/(4−1), the switching devices Q₂ and Q₃ are turned off, and the switching device Q₁ is turned on, so that the capacitors C₂ and C₃ may be charged as indicated by the arrow path shown in FIG. 8B. That is, the AC power source may charge the capacitors C₂ and C₃ through Q₁₀, the current limiter R, switching devices Q₁₁, Q₇, Q₁, Q₆, Q₅, and Q₄.
When 2×V_{acpeak}/(4−1)<Vᵢₙ≤V_{acpeak}, the switching devices Q₁, Q₂, and Q₃ are all turned off, so that only the capacitor C₃ is charged as indicated by the arrow path shown in FIG. 8C. That is, the AC power source may charge the capacitor C₃ through Q₁₀, the current limiter R, switching devices Q₁₁, Q₇, Q₆, Q₅, and Q₄.

After the n-th AC cycle, all the flying capacitors C₁, C₂ and the output capacitor C₃ are charged to their target voltage levels. After the pre-charging process is completed, switching devices Q₉ and Q₁₀ may be turned on to operate as a normal 4-level FCML converter.

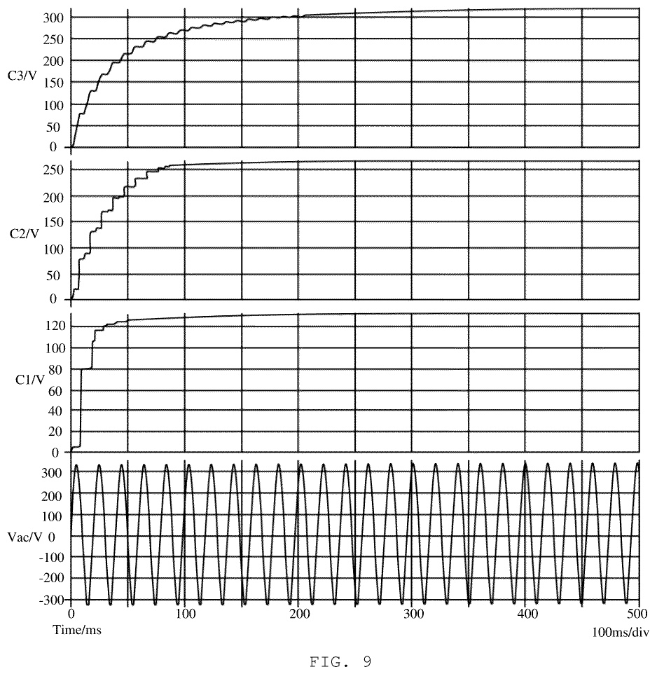

FIG. 9 shows a waveform diagram of the voltage levels of the flying capacitors C₁, C₂ and the output capacitor C₃ during pre-charging based on the target output voltage in the case of an AC power source according to an example embodiment of the present disclosure. In this example, the current limiter R is used in series with the BDS to limit inrush current. For the capacitor Cᵢ, the target flying capacitor voltage may be chosen as (i/(N−1)) times the target bulk capacitor regulated voltage (e.g., 400 V), where N is 4. That is, VC₁=133 V and VC₂=266 V, for example. The MCU may continuously monitor the AC to determine ON/OFF timing of the HF FETs. After several AC cycles, all the flying capacitors and the output capacitor may be charged to their target voltage levels.

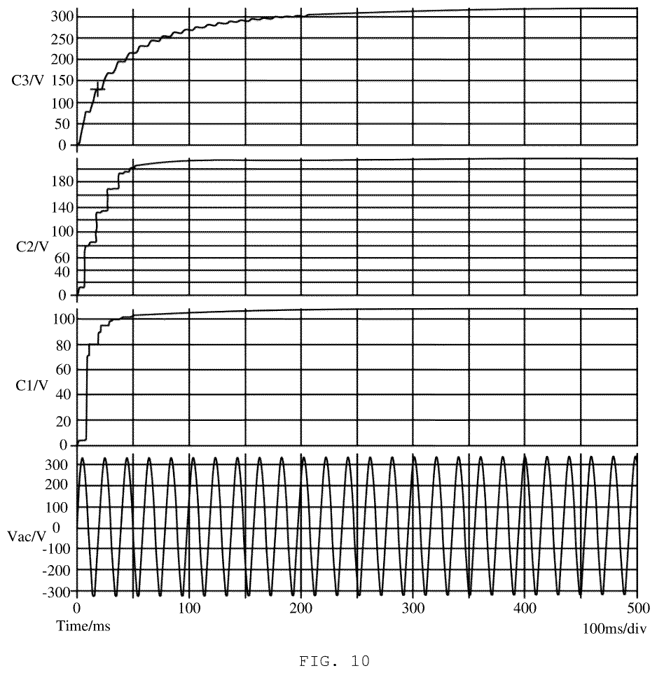

FIG. 10 shows a waveform diagram of the voltage levels of the flying capacitors C₁, C₂ and the output capacitor C₃ during pre-charging based on the target AC peak voltage in the case of an AC power source according to an example embodiment of the present disclosure. In this example, the current limiter R is used in series with the BDS to limit inrush current. For the capacitor Cᵢ, the target flying capacitor voltage may be chosen as (i/(N−1)) times the AC peak voltage, where N is 4. Before the BDS is turned on, the MCU measures the AC peak voltage to determine the flying capacitor voltage and the ON/OFF timing of the HF FETs. In addition, all the flying capacitors C₁, C₂ and the output capacitor C₃ may be charged within one AC cycle.

In Case 2, the external power source may be a DC power source.

As described above, prior to the pre-charging with the electrical power received by the power input terminal, the auxiliary converter is powered up first to provide an internal voltage Vcc. Once all internal voltages Vcc are ready, the controller 108 (e.g., the MCU) measures the input level and polarity of the DC to initiate the pre-charging process. In an example embodiment, prior to the pre-charging with the electrical power received by the power input terminal, the auxiliary converter 106 may be powered up first to provide the internal voltage, enabling the controller to measure the input voltage Vᵢₙ and polarity of the DC to initiate the pre-charging. In addition, the controller may continuously monitor the voltage V_{c} of the output capacitor C_{OUT}.

When the BDS is turned on, the voltage across the HF FETs may rise as the output capacitor C_{OUT} is charged. By appropriately controlling ON/OFF of the HF FETs, all the flying capacitors may be gradually charged so that the HF FETs are not overloaded.

When the polarity of the DC power source, as measured by the controller 106, is positive, the situation is similar to the case where the live line is positive with an AC power source. All bottom HF FETs except switching device Q_{N} may be turned on (for an N-level FCML converter, it may include 2×(N−1) HF FETs in series, and the inductor L_{IN} is connected to the source of switching device Q_{N-1} and the drain of switching device Q_{N}) to charge all the flying capacitors (e.g., C₁ to C_{N-2}) and the output capacitor C_{OUT} (e.g., C_{N-1}) because they are now connected in parallel.

That is, the N-th sixth switching device Q_{N} may be turned off, the (N+1)-th sixth switching device Q_{N+1} to the (2N−2)-th sixth switching device Q_{2N-2} may be turned on, and the body diodes of the 1^{st} sixth switching device Q₁ to the (N−1)-th sixth switching device Q_{N-1} are forward biased. Accordingly, current may flow through the second switching device Q_{b}, the current limiter R, the fifth switching device Qₑ, the third switching device Q_{c}, and the sixth switching devices except switching device Q_{N} among the plurality of sixth switching devices to charge all the flying capacitors and the output capacitor. At this time, the DC power source may charge all the flying capacitors (e.g., C₁ to C_{N-2}) and the output capacitor (e.g., C_{OUT}, which may also considered as C_{N-1}).

The controller may continuously monitor the voltage V_{c} across the output capacitor C_{OUT}. When the voltage V_{c} approaches the first voltage level Vᵢₙ/(N−1), the switching device Q_{N+1} is turned off, causing flying capacitor C₁ to be disconnected from the input and stop being charged. All the remaining flying capacitors and the capacitor C_{OUT} continue being charged to the next voltage level. For an N-level FCML converter, the charging process of the flying capacitors and the capacitor C_{OUT} may be divided into (N−1) states, where Q_{N+i}, . . . , Q_{2*(N-1)} are turned on to charge Cᵢ, . . . , C_{N-2}, while the output capacitor C_{OUT} may be charged regardless of whether the HF FETs are turned on or turned off.

In an example embodiment, when the voltage V_{c} is greater than (i−1)×Vᵢₙ/(N−1) and less than or equal to i×Vᵢₙ/(N−1), the 1^{st} sixth switching device Q₁ to the (N+i−1)-th sixth switching device Q_{N+i-1} are turned off, the (N+i)-th sixth switching device Q_{N+i} to the (2N−2)-th sixth switching device Q_{2×(N-1)} are turned on, and the DC power source may charge the i-th flying capacitor Cᵢ to the (N−2)-th flying capacitor C_{N-2} and the output capacitor C_{OUT} through conduction of the body diodes of the 1^{st} sixth switching device Q₁ to the (N−1)-th sixth switching device Q_{N-1}. When the voltage V_{c} is greater than (N−2)×Vᵢₙ/(N−1) and less than or equal to Vᵢₙ, the 1^{st} sixth switching device Q₁ to the (2N−2)-th sixth switching device Q_{2N-2} are turned off, and the DC power source may charge the output capacitor C_{OUT} through conduction of the body diodes of the 1^{st} sixth switching device Q₁ to the (N−1)-th sixth switching device Q_{N-1}.

When the polarity is negative, the situation is similar. The only difference is that all turn-on and turn-off operations occur on the top FETs (Q₁, . . . , Q_{N-1}).

That is, the (N−1)-th switching device Q_{N-1} may be turned off, the 1^{st} switching device Q₁ to the (N−2)-th switching device Q_{N-2} may be turned on, and the body diodes of the N-th switching device Q_{N} to the (2N−2)-th switching device Q_{2N-2} are forward biased. Accordingly, current may flow through the fourth switching device Q_{d}, the current limiter R, the fifth switching device Qₑ, the first switching device Qₐ, and remaining sixth switching devices except Q_{N-1} among the plurality of switching devices to charge all the flying capacitors (e.g., C₁ to C_{N-2}) and the output capacitor (e.g., C_{N-1}). At this time, the DC power source may charge all the flying capacitors (e.g., C₁ to C_{N-2}) and the output capacitor C_{OUT} (e.g., C_{N-1}).

When the voltage V_{c} approaches the first voltage level (e.g., Vᵢₙ/(N−1)), the switching device Q_{N-2} is turned off, causing flying capacitor C₁ to be disconnected from the input and stop being charged. The remaining flying capacitors and the capacitor C_{OUT} continue being charged to the next voltage level. Accordingly, sixth switching devices Q₁, . . . , Q_{N-1-i} are turned on to charge flying capacitors Cᵢ, . . . , C_{N-2}, while the output capacitor C_{OUT} may be charged regardless of whether the HF FETs are turned on or turned off.

In an example embodiment, when the voltage V_{c} is greater than (i−1)×Vᵢₙ/(N−1) and less than or equal to i×Vᵢₙ/(N−1), the (N−i)-th sixth switching device Q_{N-i} to the (2N−2)-th sixth switching device Q_{2N-2} are turned off, the 1^{st} sixth switching device Q₁ to the (N−1−i)-th sixth switching device Q_{N-1-i} are turned on, and the DC power source may charge the i-th flying capacitor Cᵢ to the (N−2)-th flying capacitor C_{N-2} and the output capacitor C_{OUT} through conduction of the body diodes of the N-th sixth switching device Q_{N} to the (2N−2)-th sixth switching device Q_{2N-2}. When the voltage V_{c} is greater than (N−2)×Vᵢₙ/(N−1) and less than or equal to Vᵢₙ, the 1^{st} sixth switching device Q₁ to the (N−1)-th sixth switching device Q_{N-1} are turned off, and the DC power source may charge the output capacitor C_{OUT} through conduction of the body diodes of the N-th sixth switching device Q_{N} to the (2N−2)-th sixth switching device Q_{2N-2}.

Once the output capacitor C_{OUT} is charged to a level close to the input voltage Vᵢₙ, all the flying capacitors 104 and the output capacitor C_{OUT} may be charged to their target levels. After the pre-charging process is completed, the bypass switches (i.e., the third switching device Q_{c} and the fourth switching device Q_{d}) may be turned on to operate as a normal N-level FCML converter.

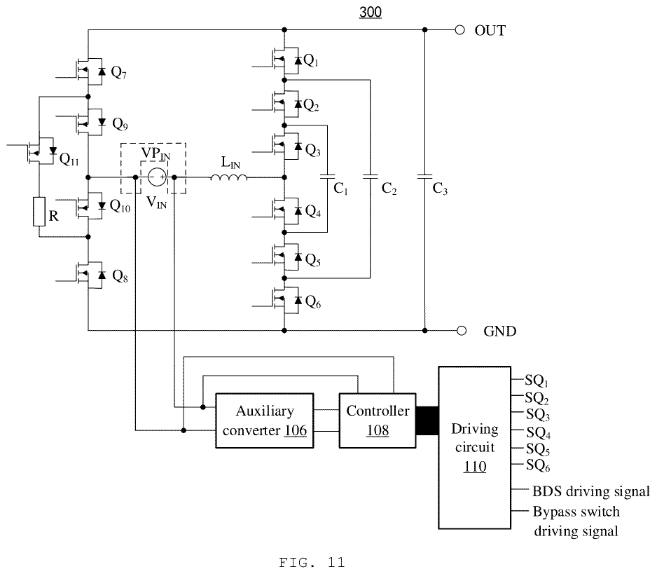

To further describe the above operation in detail, reference is now made to FIG. 11 to FIGS. 13A to 13C, in which a 4-level FCML converter (N=4) is used as an example to illustrate the flying capacitor pre-charging process for a DC power source.

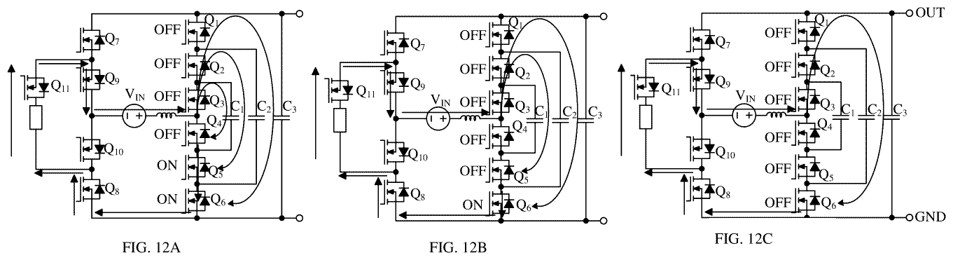

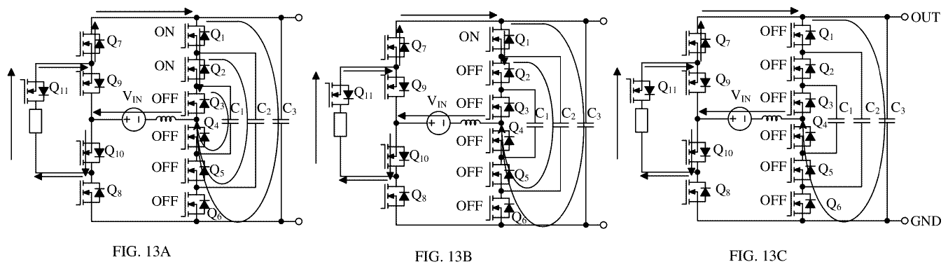

FIG. 11 shows a schematic diagram of a 4-level FCML converter circuit 300 for a DC power source according to an example embodiment. FIGS. 12A to 12C show schematic diagrams of a flying capacitor pre-charging process when the polarity is positive according to an example embodiment of the present disclosure. FIGS. 13A to 13C show schematic diagrams of a flying capacitor pre-charging process when the polarity is negative according to an example embodiment of the present disclosure.

As shown in FIG. 11, the plurality of sixth switching devices (e.g., 102 in FIG. 5) may include six switching devices, namely Q₁ to Q₆. The flying capacitors (e.g., 104 in FIG. 5) may include two flying capacitors, namely C₁ and C₂. Here, the flying capacitor C₁ may be connected across the switching device Q₂ and the switching device Q₅, and the flying capacitor C₂ may be connected across the switching device Q₁ and the switching device Q₆. For a 4-level FCML converter, the charging process of the flying capacitors and the capacitor C_{OUT} (i.e., the output capacitor C₃) is divided into three states.

As shown in FIGS. 12A to 12C, when the polarity is positive, the body diodes of the switching devices Q₁, Q₂, and Q₃ are forward biased:
When V_{c}≤Vᵢₙ/(4−1), the switching device Q₄ is turned off, while the switching devices Q₅ and Q₆ are turned on, so that the capacitors C₁, C₂, and C₃ may be charged as indicated by the arrow path shown in FIG. 12A. That is, the DC power source may charge the capacitors C₁, C₂, and C₃ through Q₈ (e.g., the second switching device Q_{b} in FIG. 5), the current limiter R, switching device Q₁₁ (e.g., the fifth switching device Qₑ in FIG. 5), switching device Q₉ (e.g., the third switching device Q_{c} in FIG. 5), switching devices Q₃, Q₂, Q₁, Q₅, and Q₆. Here, Vᵢₙ may be the DC input level measured by the controller 108, and V_{c} is the voltage of the output capacitor C_{OUT} continuously monitored by the controller 108. The controller 108 may measure the level of the input voltage Vᵢₙ and continuously monitor the voltage of the output capacitor C_{OUT}, and control the sixth switching devices (i.e., Q₁ to Q₆) through the driving circuit 110.
When Vᵢₙ/(4−1)<V_{c}≤2×Vᵢₙ/(4−1), the switching devices Q₄ and Q₅ are turned off, while the switching device Q₆ is turned on, so that the capacitors C₂ and C₃ may be charged as indicated by the arrow path shown in FIG. 12B. That is, the DC power source may charge the capacitors C₂ and C₃ through Q₈, the current limiter R, switching devices Q₁₁, Q₉, Q₃, Q₂, Q₁, and Q₆.
When 2×Vᵢₙ/(4−1)<V_{c}≤Vᵢₙ, the switching devices Q₄, Q₅, and Q₆ are all turned off, so that only the capacitor C₃ is charged as indicated by the arrow path shown in FIG. 12C. That is, the DC power source may charge the capacitor C₃ through switching device Q₈, the current limiter R, switching devices Q₁₁, Q₉, Q₃, Q₂, and Q₁.

As shown in FIGS. 13A to 13C, when the polarity is negative, the body diodes of the switching devices Q₄, Q₅, and Q₆ are forward biased:
When V_{c}≤Vᵢₙ/(4−1), the switching device Q₃ is turned off, while the switching devices Q₁ and Q₂ are turned on, so that C₁, C₂, and C₃ may be charged as indicated by the arrow path shown in FIG. 13A. That is, the DC power source may charge the capacitors C₁, C₂, and C₃ through Q₁₀ (e.g., the fourth switching device Q_{d} in FIG. 5), the current limiter R, Q₁₁, Q₇ (e.g., the first switching device Qₐ in FIG. 5), Q₁, Q₂, Q₆, Q₅, and Q₄.
When Vᵢₙ/(4−1)<V_{c}≤2×Vᵢₙ/(4−1), the switching devices Q₂ and Q₃ are turned off, while the switching device Q₁ is turned on, so that C₂ and C₃ may be charged as indicated by the arrow path shown in FIG. 13B. That is, the DC power source may charge the capacitors C₂ and C₃ through Q₁₀, the current limiter R, Q₁₁, Q₇, Q₁, Q₆, Q₅, and Q₄.
When 2×Vᵢₙ/(4−1)<V_{c}≤Vᵢₙ, the switching devices Q₁, Q₂, and Q₃ are all turned off, so that only C₃ may be charged as indicated by the arrow path shown in FIG. 13C. That is, the DC power source may charge the capacitor C₃ through Q₁₀, the current limiter R, Q₁₁, Q₇, Q₆, Q₅, and Q₄.

Once the output capacitor C_{OUT} (i.e., C₃) is charged to a level close to the input voltage Vᵢₙ, all the flying capacitors C₁, C₂ and the output capacitor C₃ are charged to their target levels. After the pre-charging is completed, switching devices Q₉ and Q₁₀ may be turned on to operate as a normal 4-level FCML converter.

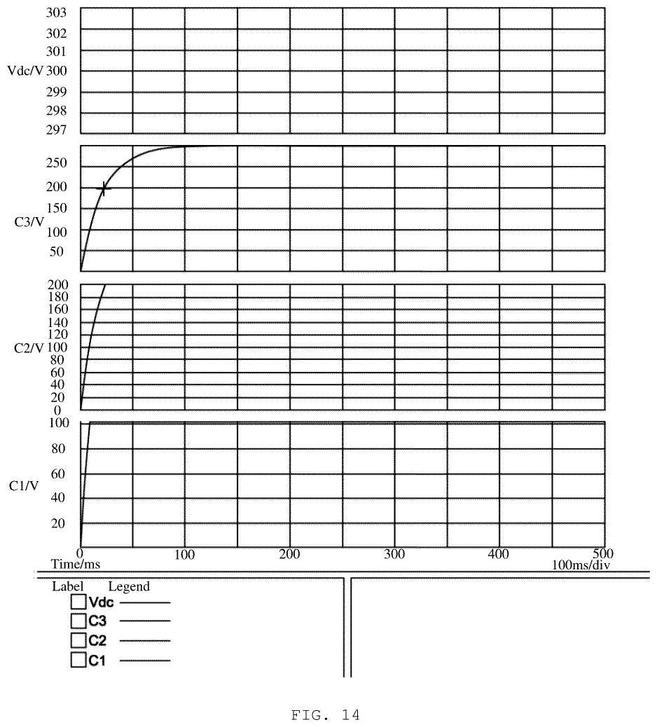

FIG. 14 shows a waveform diagram of the voltage levels of the flying capacitors C₁, C₂ and the output capacitor C₃ during pre-charging in the case of a DC power source according to an example embodiment of the present disclosure. In this example, the current limiter R is used in series with the BDS to limit inrush current. For the input voltage Vᵢₙ=300 V, for example, the target flying capacitor voltage of the capacitor Cᵢ may be VC₁=100V and VC₂=200V, for example. As shown, C₁ is first charged to 100 V, then C₂ is charged to 200 V, and finally C₃ is charged to 300 V.

The example embodiments of the present disclosure have been described above in detail with reference to the accompanying drawings. However, the specific structures are not limited to the above-described example embodiments. References to “an example embodiment”, “example embodiments”, and the like in the present disclosure indicate that the described example embodiment may include a particular feature, structure, or characteristic, but not every example embodiment necessarily includes the particular feature, structure, or characteristic. Moreover, such phrases do not necessarily refer to the same example embodiment. Further, when a particular feature, structure, or characteristic is described in conjunction with an example embodiment, it should be considered that implementing such a feature, structure, or characteristic in conjunction with other example embodiments (whether explicitly described or not) is within the knowledge of those skilled in the art.

It should be understood that although terms such as “first”, “second” and the like may be used herein to describe various elements, these elements should not be limited by such terms. These terms are only used to distinguish one element from another. For example, without departing from the scope of the present disclosure, a first element may be referred to as a second element, and similarly, a second element may be referred to as a first element. As used herein, the term “and/or” includes any and all combinations of one or more of the associated listed items.

Many changes and modifications may be made to the example embodiments without substantially departing from the principles of the inventive concept. All such changes and modifications are intended to be included within the scope of the inventive concept described herein. Therefore, the subject matter described above is to be understood as illustrative rather than restrictive, and the exemplary example embodiments are intended to cover all such modifications, improvements, and other example embodiments that fall within the spirit and scope of the inventive concept. Therefore, to the maximum extent permitted by law, the scope of the inventive concept should be determined by the broadest permissible interpretation of the present disclosure, including the exemplary example embodiments and their equivalents, and should not be limited to or restricted by the foregoing specific example embodiments.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A flying capacitor multi-level (FCML) converter circuit comprising:
an output capacitor connected in parallel across output terminals;
a first switching device, a fifth switching device, a current limiter, and a second switching device connected in series, wherein the first switching device, the fifth switching device, the current limiter, and the second switching device are connected in parallel with the output capacitor, and wherein the fifth switching device is integrated with the first switching device and the second switching device to function as a bidirectional switch (BDS);
a third switching device and a fourth switching device connected in series, wherein the third switching device and the fourth switching device are connected in parallel with the current limiter and the fifth switching device, and wherein the third switching device and the fourth switching device function as bypass switches;
a plurality of sixth switching devices connected in series, wherein a flying capacitor is connected across the plurality of sixth switching devices, and wherein the plurality of sixth switching devices connected in series are connected in parallel with the output capacitor;
a power input terminal and an inductor connected in series between a node between the third switching device and the fourth switching device and a node between two central sixth switching devices among the plurality of sixth switching devices, wherein the power input terminal is configured to receive electrical power; and
a controller coupled to the power input terminal; wherein under control of the controller, the electrical power received by the power input terminal pre-charges the flying capacitor and the output capacitor through a corresponding sixth switching device among the plurality of sixth switching devices, the first switching device, the second switching device, the third switching device, the fourth switching device, the fifth switching device, and the current limiter.

2. The FCML converter circuit of claim 1, further comprising a driving circuit coupled to the controller, wherein
the controller is configured to control turn-on and turn-off of the first switching device, the second switching device, the third switching device, the fourth switching device, the fifth switching device, and the plurality of sixth switching devices through the driving circuit.

3. The FCML converter circuit of claim 1, further comprising:
an auxiliary converter coupled to the power input terminal and to the controller, wherein
the power input terminal is configured to receive electrical power from an external power source; and
prior to pre-charging with the electrical power received by the power input terminal, the auxiliary converter is powered up first by receiving electrical power from the power input terminal to provide an internal voltage.

4. The FCML converter circuit of claim 3, wherein
the FCML converter circuit is an N-level FCML converter, and N is a positive integer greater than or equal to 3;
the plurality of sixth switching devices include 2×(N−1) sixth switching devices, the flying capacitor includes (N−2) flying capacitors, an i-th flying capacitor is connected across an (N−1−i)-th sixth switching device and an (N+i)-th sixth switching device among the 2×(N−1) sixth switching devices, where i=1, 2, . . . , N−2; and
the (N−2) flying capacitors have (N−2) different target flying capacitor voltage levels.

5. The FCML converter circuit of claim 4, wherein the plurality of sixth switching devices include high-frequency (HF) field-effect transistors (FETs), the inductor is connected to a source of an (N−1)-th sixth switching device and a drain of an N-th sixth switching device, and the i-th flying capacitor among the (N−2) flying capacitors is connected across a source of the (N−1−i)-th sixth switching device and a drain of the (N+i)-th sixth switching device among the 2×(N−1) sixth switching devices.

6. The FCML converter circuit of claim 4, wherein
the external power source includes an alternating current (AC) power source, and prior to the pre-charging with the electrical power received by the power input terminal, the auxiliary converter is powered up first to provide an internal voltage, such that the controller monitors the AC power source to control a BDS turn-on phase angle and initiate the pre-charging; and
the controller is configured to acquire a peak voltage V_{acpeak} of the AC power source and to continuously monitor an input voltage Vᵢₙ of the AC power source and a voltage V_{c} of the output capacitor.

7. The FCML converter circuit of claim 6, wherein
when a live line is positive, current flows through the second switching device, the current limiter, the fifth switching device, and the third switching device;
when the input voltage Vᵢₙ is greater than (i−1)×V_{acpeak}/(N−1) and less than or equal to i×V_{acpeak}/(N−1), a 1^{st} sixth switching device to an (N+i−1)-th sixth switching device are turned off, an (N+i)-th sixth switching device to a (2N−2)-th sixth switching device are turned on, and the AC power source charges an i-th flying capacitor to an (N−2)-th flying capacitor and the output capacitor through conduction of body diodes of the 1^{st} sixth switching device to the (N−1)-th sixth switching device; and
when the input voltage Vᵢₙ is greater than (N−2)×V_{acpeak}/(N−1) and less than or equal to the peak voltage V_{acpeak}, the 1^{st} sixth switching device to the (2N−2)-th sixth switching device are turned off, and the AC power source charges the output capacitor through conduction of body diodes of the 1^{st} sixth switching device to the (N−1)-th sixth switching device.

8. The FCML converter circuit of claim 7, wherein, when the voltage V_{c} reaches the peak voltage V_{acpeak}, the (N−2) flying capacitors and the output capacitor are charged to target levels, and the third switching device and the fourth switching device are turned on.

9. The FCML converter circuit of claim 7, wherein, through turn-on and turn-off of the plurality of sixth switching devices, the AC power source charges all the (N−2) flying capacitors and the output capacitor within one AC cycle.

10. The FCML converter circuit of claim 6, wherein
when a neutral line is positive, current flows through the fourth switching device, the current limiter, the fifth switching device, and the first switching device;
when the input voltage Vᵢₙ is greater than (i−1)×V_{acpeak}/(N−1) and less than or equal to i×V_{acpeak}/(N−1), the (N−i)-th sixth switching device to the (2N−2)-th sixth switching device are turned off, the 1^{st} sixth switching device to the (N−1−i)-th sixth switching device are turned on, and the AC power source charges the i-th flying capacitor to the (N−2)-th flying capacitor and the output capacitor through conduction of body diodes of the N-th sixth switching device to the (2N−2)-th sixth switching device; and
when the input voltage Vᵢₙ is greater than (N−2)×V_{acpeak}/(N−1) and less than or equal to the peak voltage V_{acpeak}, the 1^{st} sixth switching device to the (2N−2)-th sixth switching device are turned off, and the AC power source charges the output capacitor through conduction of body diodes of the N-th sixth switching device to the (2N−2)-th sixth switching device.

11. The FCML converter circuit of claim 10, wherein, when the voltage V_{c} reaches the peak voltage V_{acpeak}, the (N−2) flying capacitors and the output capacitor are charged to target levels, and the third switching device and the fourth switching device are turned on.

12. The FCML converter circuit of claim 10, wherein, through turn-on and turn-off of the plurality of sixth switching devices, the AC power source charges all the (N−2) flying capacitors and the output capacitor within one AC cycle.

13. The FCML converter circuit of claim 4, wherein
the external power source includes a direct current (DC) power source, and prior to the pre-charging with the electrical power received by the power input terminal, the auxiliary converter is powered up first to provide an internal voltage, such that the controller is configured to measure an input voltage Vᵢₙ and a polarity of the DC power source to initiate the pre-charging; and
the controller is configured to continuously monitor the voltage V_{c} of the output capacitor.

14. The FCML converter circuit of claim 13, wherein
when the polarity is positive, current flows through the second switching device, the current limiter, the fifth switching device, and the third switching device;
when the voltage V_{c} is greater than (i−1)×Vᵢₙ/(N−1) and less than or equal to i×Vᵢₙ/(N−1), the 1^{st} sixth switching device to the (N+i−1)-th sixth switching device are turned off, the (N+i)-th sixth switching device to the (2N−2)-th sixth switching device are turned on, and the DC power source charges the i-th flying capacitor to the (N−2)-th flying capacitor and the output capacitor through conduction of body diodes of the 1^{st} sixth switching device to the (N−1)-th sixth switching device; and
when the voltage V_{c} is greater than (N−2)×Vᵢₙ/(N−1) and less than or equal to Vᵢₙ, the 1^{st} sixth switching device to the (2N−2)-th sixth switching device are turned off, and the DC power source charges the output capacitor through conduction of body diodes of the 1^{st} sixth switching device to the (N−1)-th sixth switching device.

15. The FCML converter circuit of claim 14, wherein, when the voltage V_{c} approaches the input voltage Vᵢₙ, the (N−2) flying capacitors and the output capacitor are charged to target levels, and the third switching device and the fourth switching device are turned on.

16. The FCML converter circuit of claim 13, wherein
when the polarity is negative, current flows through the fourth switching device, the current limiter, the fifth switching device, and the first switching device;
when the voltage V_{c} is greater than (i−1)×Vᵢₙ/(N−1) and less than or equal to i×Vᵢₙ/(N−1), the (N−i)-th sixth switching device to the (2N−2)-th sixth switching device are turned off, the 1^{st} sixth switching device to the (N−1−i)-th sixth switching device are turned on, and the DC power source charges the i-th flying capacitor to the (N−2)-th flying capacitor and the output capacitor through conduction of body diodes of the N-th sixth switching device to the (2N−2)-th sixth switching device; and
when the voltage V_{c} is greater than (N−2)×Vᵢₙ/(N−1) and less than or equal to Vᵢₙ, the 1^{st} sixth switching device to the (2N−2)-th sixth switching device are turned off, and the DC power source charges the output capacitor through conduction of body diodes of the N-th sixth switching device to the (2N−2)-th sixth switching device.

17. The FCML converter circuit of claim 16, wherein, when the voltage V_{c} approaches the input voltage Vᵢₙ, the (N−2) flying capacitors and the output capacitor are charged to target levels, and the third switching device and the fourth switching device are turned on.
